(19) United States
(12) Patent Application Publication
(10) Pub. No.: US 2005/0238415 A1
(43) Pub. Date: Oct. 27, 2005

(54) Notebook sleeve

(76) Inventors: Edward P. Busam, Mason, OH (US); Dana M. Walker, Dayton, OH (US); Stephen D. Wehmeyer, Cincinnati, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/832,160

(22) Filed: Apr. 26, 2004

(51) Int. Cl. B42F 13/00

(52) U.S. Cl. 402/73

(57) ABSTRACT

A notebook sleeve including a first generally rectangular side panel having a top edge, a pair of side edges and a bottom edge and a second generally rectangular side panel having a top edge, a pair of side edges and a bottom edge. The second side panel is generally parallel to and generally aligned with the first side panel, The notebook sleeve further includes a bottom generally rectangular panel located between and coupled to the bottom edges of first and second side panels, the bottom panel having a pair of long edges and a pair of short edges. The notebook sleeve further includes a pair of generally parallel connecting panels, each connecting panel being located between and coupled to a side edge of each of the first and second side panels, wherein the first side panel, the second side panel, the bottom panel and the pair of connecting panels define a cavity therebetween. The first and second side panels each have a larger surface area than any of the bottom panel or the pair of connecting panels, and at least one short edge of the bottom panel includes a binding seam extending at least partially therealong.

The present invention is directed to a notebook sleeve, and more particularly, to a notebook sleeve having binding seams along its outer edges.

### BACKGROUND

Notebooks are commonly used by students and other users for taking notes, making sketches and the like. Notebooks may also be used as a source of loose-leaf paper and for storing writing instruments and other loose materials. Users of notebooks often utilize backpacks, bags, or other similar devices to carry notebooks and other components. However, backpacks and bags may not provide quick and convenient access to the stored contents and can be relatively large and bulky. Accordingly, there is a need for an improved device for storing and carrying notebooks and other materials.

The Notebook Computer Insert sold by Tumi, Inc. of South Plainfield, N.J. is a padded pocket for storing laptop computers. Due to the construction and arrangement of that pocket, the pocket includes a pair of binding seams that extend along the longitudinal bottom edges of the pocket. Thus, when a user grips the Tumi pocket along its bottom edge, the binding seams are gripped in the user's hand and may create discomfort. Furthermore, the Tumi pocket includes relatively stiff sides/connecting panels, and therefore is not easily collapsible to accommodate smaller sized-contents. Accordingly, there is a need for a device for storing notebook and other materials which does not include longitudinally-extending binding seams along its lower edge, and which is at least partially collapsible.

### SUMMARY

In one embodiment, the present invention is a notebook sleeve shaped to receive notebooks and the like therein. The notebook sleeve does not include longitudinally-extending binding seams along its lower edge, and instead includes binding seams which are positioned so that they are not gripped by a user when carrying the notebook along its bottom edge. Furthermore, the notebook sleeve may be at least partially collapsible.

In one embodiment the invention is a notebook sleeve including a first generally rectangular side panel having a top edge, a pair of side edges and a bottom edge and a second generally rectangular side panel having a top edge, a pair of side edges and a bottom edge. The second side panel is generally parallel to and generally aligned with the first side panel, The notebook sleeve further includes a bottom generally rectangular panel located between and coupled to the bottom edges of first and second side panels, the bottom panel having a pair of long edges and a pair of short edges. The notebook sleeve further includes a pair of generally parallel connecting panels, each connecting panel being located between and coupled to a side edge of each of the first and second side panels, wherein the first side panel, the second side panel, the bottom panel and the pair of connecting panels define a cavity therebetween. The first and second side panels each have a larger surface area than any of the bottom panel or the pair of connecting panels, and at least one short edge of the bottom panel includes a binding seam extending at least partially therealong.

In another embodiment, the invention is a notebook sleeve including a first generally rectangular side panel having a top edge, a pair of side edges and a bottom edge and a second generally rectangular side panel having a top edge, a pair of side edges and a bottom edge. The second side panel is generally parallel to and generally aligned with the first side panel. The notebook sleeve further includes a bottom generally rectangular panel located between and coupled to the bottom edges of first and second side panels, the bottom panel having a pair of long edges and a pair of short edges. The notebook sleeve further includes a pair of generally parallel connecting panels, each connecting panel being located between and coupled to a side edge of each of the first and second side panels. The first side panel, the second side panel, the bottom panel and the pair of connecting panels define a cavity therebetween, the cavity having a mouth. The first and second side panels each have a larger surface area than any one of the bottom panel or the pair of connecting panels, and the notebook sleeve does not include any binding seams located adjacent to and extending along the bottom edges of the side panels. The notebook sleeve further includes a closure mechanism movable between a closed position wherein the closure mechanism extends laterally across the mouth to releasably couple the side panels together and an open position wherein the closure mechanism does not releasably couple the side panels together, and wherein the closure mechanism extends less than an entire length of the mouth in a longitudinal direction when the closure mechanism is in the closed position.

Other objects and advantages of the present invention will be apparent from the following description and the accompanying drawings.

### BRIEF DESCRIPTION OF THE DRAWINGS

FIG. 1 is a front perspective view of one embodiment of the notebook sleeve of the present invention, with the closure mechanism in its closed position;

FIG. 2 is a front perspective view of the notebook sleeve of FIG. 1, with the closure mechanism in its open position;

FIG. 3 is a front perspective view of the notebook sleeve of FIG. 2, with a notebook partially inserted therein;

FIG. 4 is a front perspective view of the notebook sleeve of FIG. 3, with the notebook fully inserted therein and the auxiliary pocket in an open position;

FIG. 5 is a front perspective view of another embodiment of the notebook sleeve of the present invention;

FIGS. 6-10 are a series of schematic views illustrating one method for assembling the notebook sleeve of the present invention;

FIG. 11 is a cross section taken along line 11-11 of FIG. 9; and

FIG. 12 is a cross section taken along line 12-12 of FIG. 9.

### DETAILED DESCRIPTION

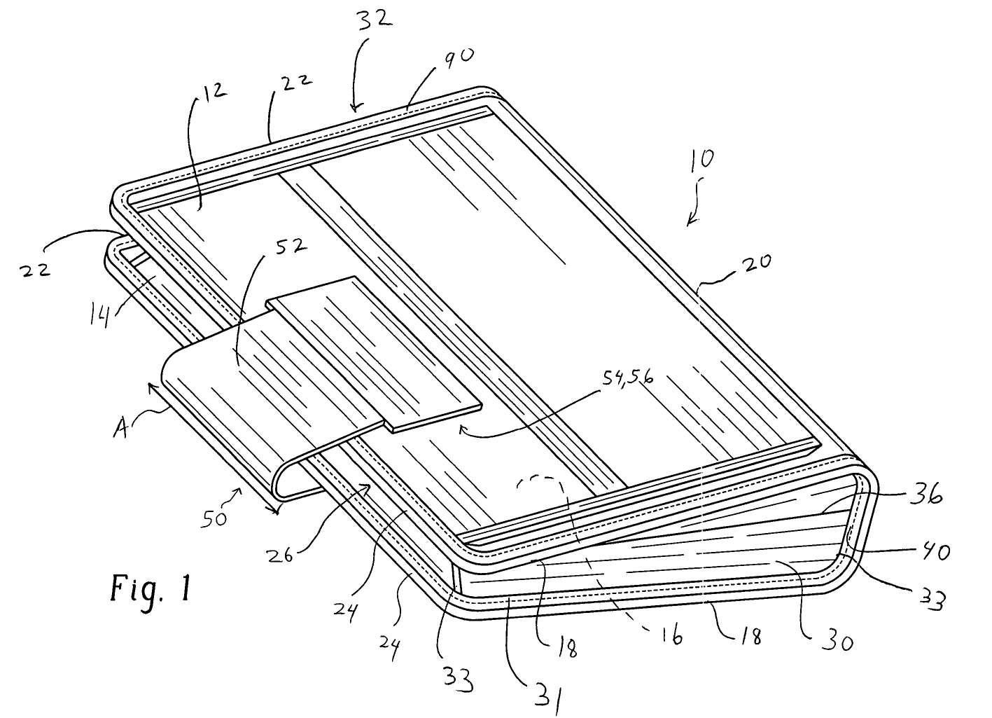

As shown in FIGS. 1-5 the notebook sleeve of the present invention, generally designated 10, includes a first side panel 12 and a second side panel 14 generally aligned with the first side panel 12, the first 12 and second 14 side panels defining a cavity or main cavity 16 therebetween. Each of the first 12 and second 14 side panels may be generally flat and rectangular and have a first or side edge 18, a second or bottom edge 20, third or side edge 22 and fourth or top edge 24. The cavity 16 may include a mouth or a main mouth 26 for providing access to the cavity 16, with the mouth 26 being located between the top edges 24. Each of the first 12 and second 14 side panels may be made of a variety of materials, such as a cardboard backing materials having an outer woven fabric covering.

The notebook sleeve 10 may include a pair of connecting panels 30, 32 coupled to, located between or extending between the first 12 and second 14 side panels. Each connecting panel 30, 32 includes a pair of long edges 31 and a pair of short edges 33. The first connecting panel 30 may be located between and coupled to the first outer edges 18 of the first 12 and second 14 side panels, and the second connecting panel 32 may be located between and coupled to the third outer edges 22 of the first 12 and second 14 side panels. The connecting panels 30, 32 may be made of a material having greater flexibility than that of the first 12 and second 14 side panels. For example, each of the connecting panels 30, 32 may be made of a woven fabric and may lack the cardboard backing of the front and second 14 panels. As can be seen in the drawings, the connecting panels 30, 32 may be made of a flexible expandable/collapsible material, and may, for example, include various folds 36 to facilitate the folding/collapsing of the connecting panels 30, 32.

The notebook sleeve 10 may include a bottom panel 40 coupled to, located between or extending between the first 12 and second 14 side panels. The bottom panel 40 has a pair of long edges and a pair of short edges, and is oriented generally perpendicular to the first 12 and second 14 side panels. The bottom panel 40 is located between the bottom edges 20 of the first 12 and second 14 side panels, and is thereby located on a generally opposite side of the notebook sleeve 10 relative to the mouth 26.

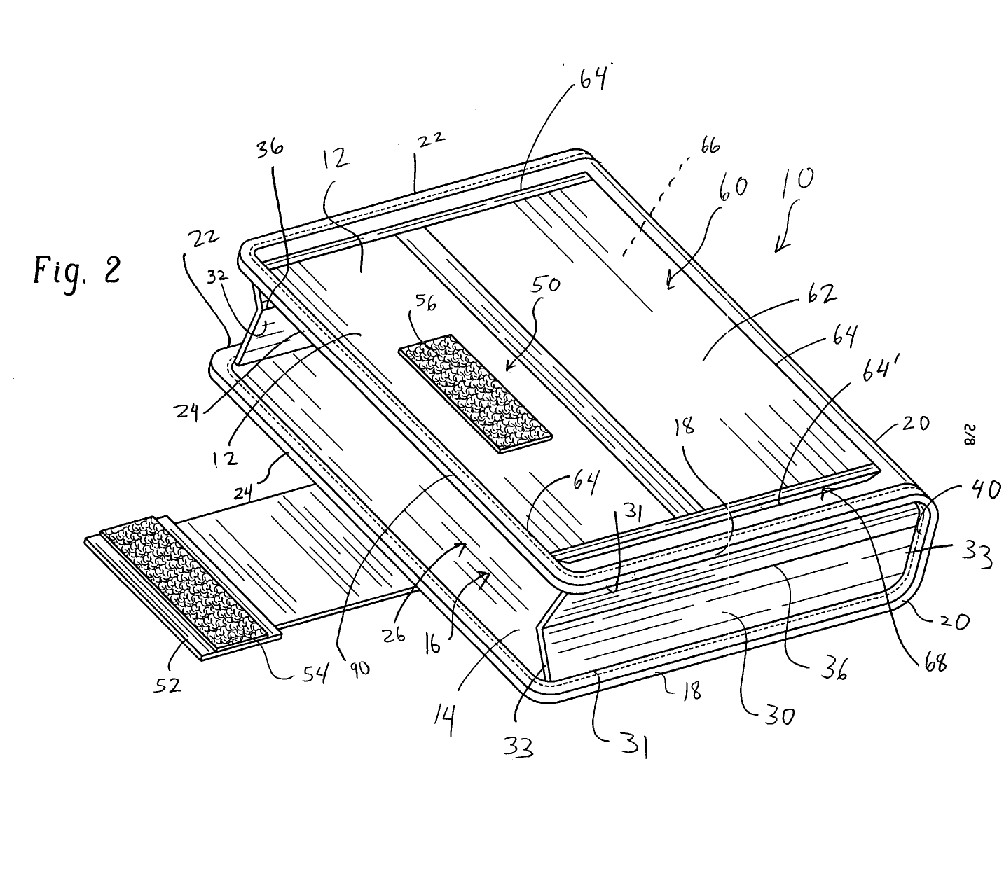

The bottom panel 40 may be made of material similar to that of the first 12 and second 14 side panels, and both the first 12 and second 14 side panels may be pivotally coupled to the bottom panel 40. For example, FIG. 1 illustrates the first 12 and second 14 side panels wherein their top edges 24 are located relatively close to each other and the connecting panels 30, 32 are at least partially collapsed, and FIG. 2 illustrates the notebook sleeve 10 with the mouth 26 more fully opened such that the top edges 24 of the first 12 and second 14 side panels are spaced apart from each other and the connecting panels 30, 32 are expanded. The bottom panel 40 may include a longitudinally-extending crease to allow flexure of the bottom panel 40. The first 12 and second 14 side panels are, in the illustrated embodiment, the largest panels. In other words, the first 12 and second 14 side panels each have a larger surface area than either of the bottom panel 40 or the connecting panels 30, 32.

The notebook sleeve 10 includes a closure mechanism or main closure mechanism, generally designated 50. In the illustrated embodiment, the closure mechanism 50 includes a strap 52 which is fixedly coupled to the second side panel 14 by any of a wide variety of mechanisms (i.e. stitching, bonding, adhesives etc.). The strap 52 is spaced away from the outer edges of the notebook sleeve 10 (i.e. spaced apart from the ends of the top edges 24) and may be laterally centered on the notebook sleeve 10. The strap 52 may be made of a generally flexible material and include a patch of hook-and-loop fastening material 54 (such as VELCRO®) located at a distal end thereof.

The first side panel 12 may include a corresponding patch of hook-and-loop fastening material 56 located thereon. In this manner, the strap 52 is movable to a closed position wherein the strap 52 extends laterally across the mouth 26 to releasably couple the first 12 and the second 14 side panels together and the patches 54, 56 of hook-and-loop fastening material are engaged (FIG. 1). The strap 52 is also moveable to an open position wherein the patches 54, 56 of hook-and-loop fastening material are not engaged (FIGS. 2-4). When in the open position, the strap 52 does not releasably couple the first 12 and second 14 side panels together and the strap 52 does not extend across the mouth 26.

As shown in FIG. 1, the strap 52 has a width extending in the longitudinal direction A which is less than that than of the length (also extending in direction A) of the mouth 26. In this manner, the strap 52 covers less than the entire length of the mouth 26 when the strap 52 is in its closed position. This shape of the strap 52 allows the contents of the notebook sleeve 10 to be viewed and provides access to the cavity 16, while still retaining the contents therein. Furthermore, because the strap 52 extends a relatively short length along the mouth 26, the strap 52 can be quickly and easily operated to open the notebook sleeve 10.

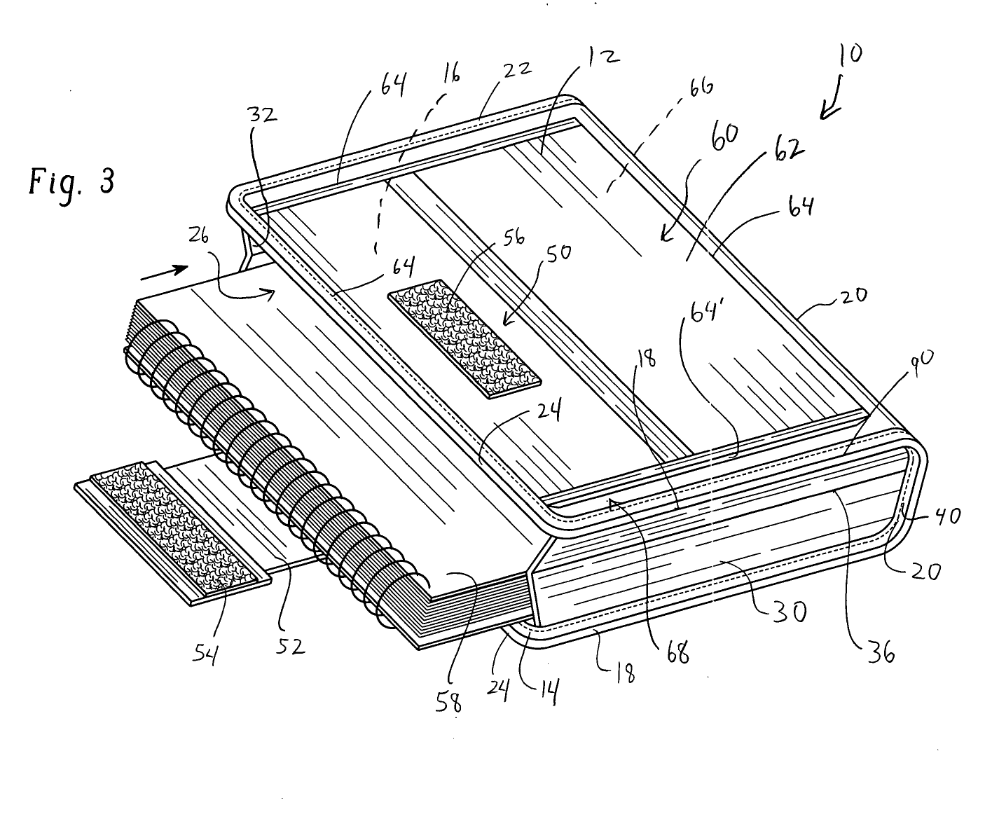

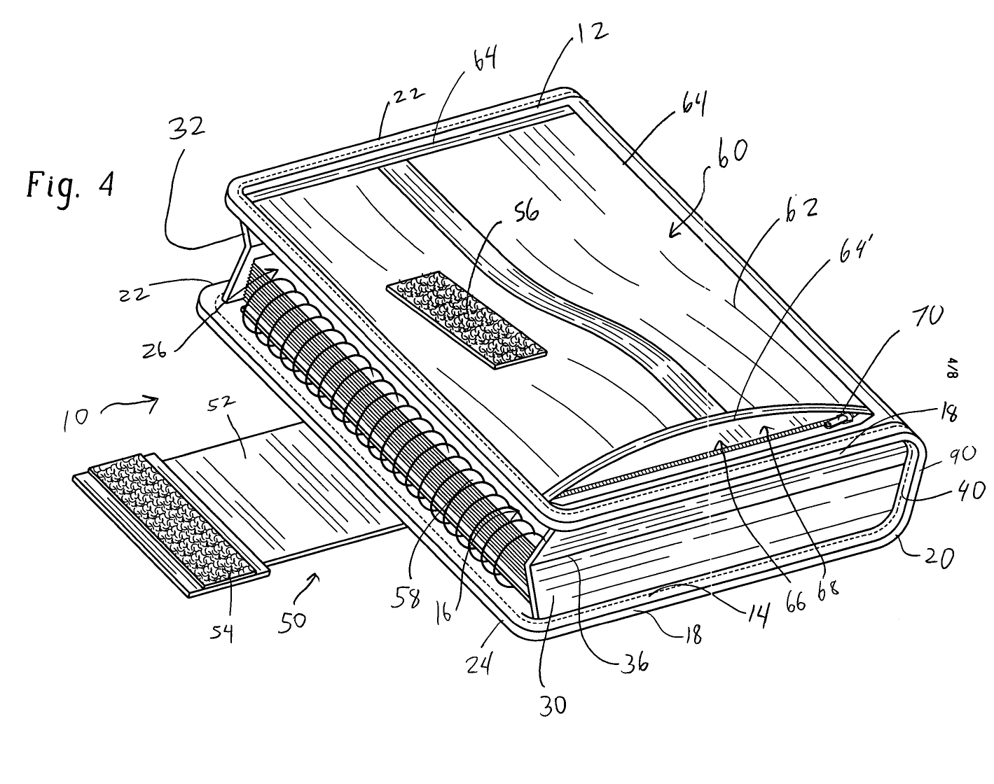

FIG. 3 illustrates a notebook 58 partially inserted through the mouth 26 and into the cavity 16 of the notebook sleeve 10, and FIG. 4 illustrates the notebook 58 fully received in the cavity 16. Because the notebook sleeve 10 may be sized to generally closely receive the notebook 58 therein, when the strap 52 is moved to its closed position the strap 52 still retain the notebook 58 in the cavity 16 even though the strap 52 extends less the entire length of the mouth 26. Thus, the pocket cavity 16 may be shaped the size to generally closely receive a notebook having a height of between about 10 and about 12 inches and a width of between about 8 inches and about 11 inches therein. The side panels 12, 14 may each have a width of between about 9 and about 13 inches and a length of between about 11 and 15 inches. The connecting panels 30, 32, and the bottom panel 40 may each have a width of between about 1 and about 3 inches.

Of course, if desired, the notebook sleeve 10 may have a variety of different shapes and configurations. Furthermore, a wide variety of structures besides the patches of hook-and-loop fastening material 54, 56 may be utilized as part of the closure mechanism 50 including, but not limited to, clasps, brackets, clips, magnets, inter-engaging geometries, cords, ties, snaps and the like.

The notebook sleeve 10 may include an auxiliary pocket 60 located on the first side panel 12 (although the auxiliary pocket 60 could be located on the second side panel 14 as an alternative or in addition). The auxiliary pocket 60 includes a generally rectangular and flat piece of auxiliary pocket material 62 having four outer pocket edges 64. The piece of auxiliary pocket material 62 is joined along three of its edges 64 to the first side panel 12, and is not joined along the fourth pocket edge 64′. The auxiliary pocket material 62 thereby defines an auxiliary pocket cavity 66 located between the auxiliary pocket material 60 and the first side panel 12 (FIG. 4).

The auxiliary pocket cavity 66 has an auxiliary pocket mouth 68 extending along the fourth outer pocket edge 64′ to provide access to the auxiliary pocket cavity 66. The auxiliary pocket mouth 68 is oriented or extends generally perpendicular to the main mouth 26 of the notebook sleeve 10, and includes an auxiliary pocket closure mechanism 70 (such as a zipper) for selectively closing the auxiliary pocket mouth 68. Of course, a wide variety of devices may be used as the auxiliary pocket closure mechanism 70, including, but not limited to, clasps, brackets, clips, magnets, inter-engaging geometries, cords, ties, snaps and the like.

Thus, in the illustrated embodiment the auxiliary pocket closure mechanism 70 extends across generally the entire auxiliary pocket mouth 68 such that the auxiliary pocket 60 may be used to store smaller, loose items which may not be able to be securely stored in the main cavity 16 of the notebook sleeve 10. Furthermore, because of the auxiliary pocket mouth 68 extends generally perpendicular to the mouth 26 of the main cavity 16 the notebook sleeve 10 provides two points of access (i.e. the two mouths 26, 68) for storing loose materials. These two mouths 26, 68 are oriented generally perpendicular and located on different surfaces of the notebook sleeve 10 so that at least one of the mouths 26, 68 may be able to be accessed when access to the other mouth is blocked (i.e. when the notebook sleeve 10 is being stored in a backpack, stored in a locker, being carried under a user's arm, etc.).

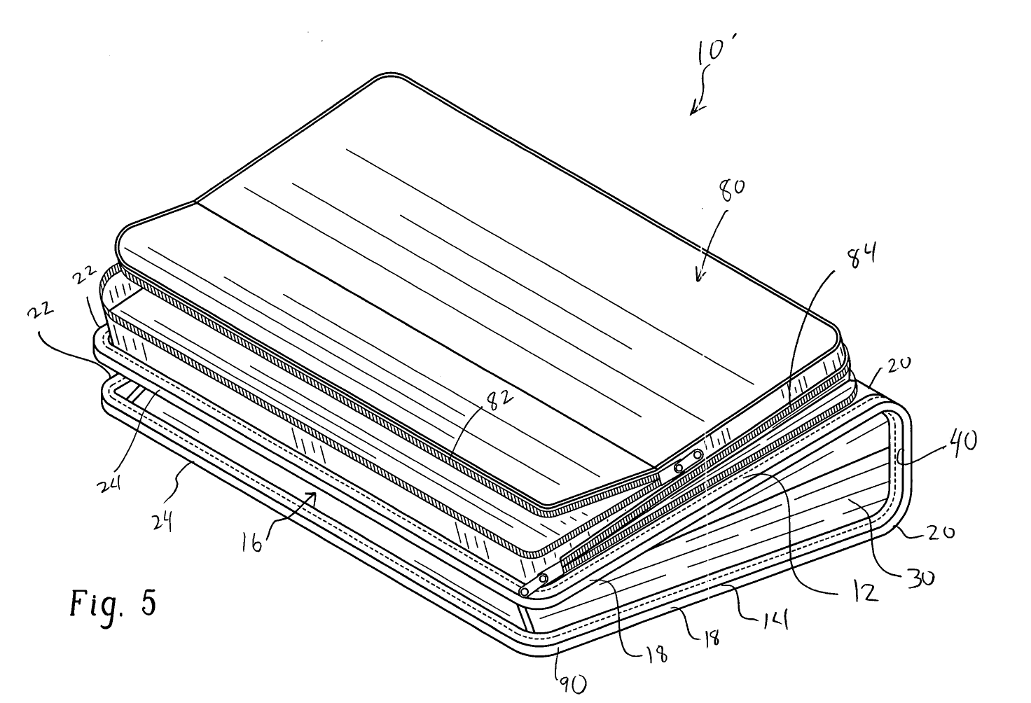

FIG. 5 illustrates an alternate embodiment of the notebook sleeve 10′ utilizing an expandable auxiliary pocket 80. The auxiliary pocket 80 includes a releasable fastener (such as a zipper) 82 for controlling access to the contents cavity of the auxiliary pocket 80, and an expansion fastener (such as a zipper) for controlling the expansion/contraction of the auxiliary pocket 80. The pocket 80 is more fully described in U.S. Pat. No. 6,558,062, the contents of which are hereby incorporated by reference.

Because the notebook sleeve 10 (or the main cavity 16) may be sized to generally closely receive a notebook 58 therein, in school usage, a single notebook sleeve 10 may be used to store a plurality of materials (i.e., text book, notebook and folder) for a single subject (i.e. english, math, history etc.). A student may use a plurality of notebook sleeves 10, with each notebook sleeve 10 storing a plurality of materials for a single class or subject. In other words, each notebook sleeve 10 may be dedicated to a single subject. Thus, a student can simply grab the appropriate notebook sleeve 10 for the subject of interest, and thereby obtained all of the relevant materials for a subject in a single motion.

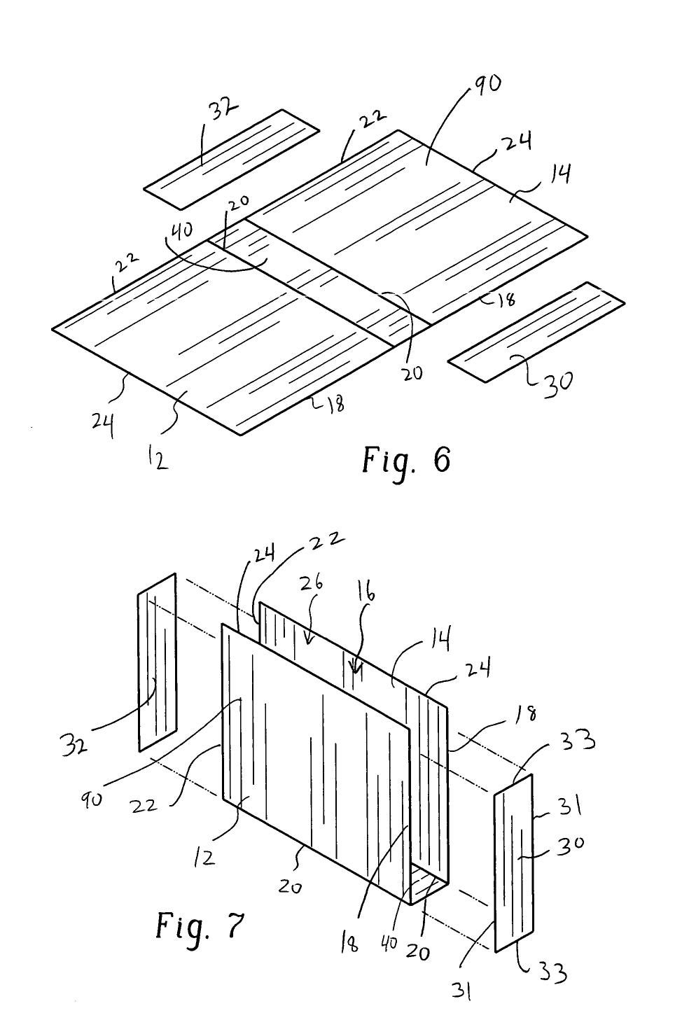

FIGS. 6-10 illustrate a series of steps which may be carried out to assemble the notebook sleeve of FIGS. 1-5. As shown in FIG. 6, the process may begin with a main panel or sheet of material 90 which includes or comprises the side panels 12, 14, as well as the bottom panel 40. The sheet 90 may be a single unitary sheet of material, or could be two or more pieces joined together. As shown in FIG. 7, the opposed side panels 12, 14 may be folded about hinge lines 20 until the panels 12, 14 are generally parallel and aligned (i.e. facing each other). Next, as shown in FIG. 8, connecting panel 30 is located between the first outer edges 18 of the first 12 and second 14 panels and connecting panel 32 is located between the third outer edges 22 of the first 12 and second 14 side panels.

If desired, the connecting panels 30, 32 may be slightly larger than the spaces between the respective side edges 18 or 22. In particular, the connecting panels 30, 32 may be slightly larger so that the connecting panels 30, 32 must be folded to fit between the side panels 12, 14. For example, FIG. 8 illustrates a thin, vertically-extending strip 30a located flush against side panel 14 and a generally horizontally-extending strip 30b flush against lower panel 40.

As shown in FIG. 9, a binding seam or stitching seam 92 is attached to various outer edges of the notebook sleeve 10. In particular, the binding seam 92 extends along the first outer edges 18, second outer edges 22 and upper edges 24 of the first 12 and second 14 side panels. The binding seam 92 may also extend along both long edges 31 of both connecting panels 30, 32, and along the bottom short edge 33 of both connecting panels 30, 32. The binding seam 92 may also extend along the short edges of the bottom panel 40 so that at least part of the binding seam 92 extends along one of the short edges of the bottom panel 40. The binding seam 92 preferably does not extend along the lower longitudinal edges of the notebook sleeve 10; that is, the lower edges 20 of the first 12 and second 14 side panels. In other words, the notebook sleeve 10 does not include any binding seams 92 located adjacent to or extending along the bottom edges 20 of the side panels 12, 14.

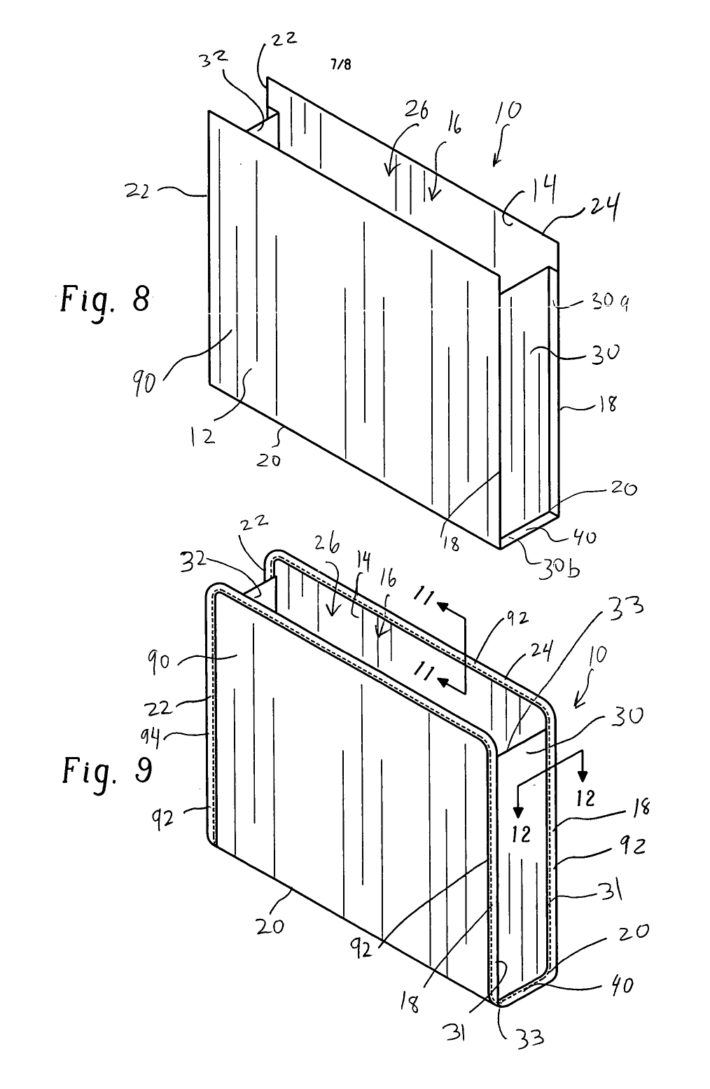

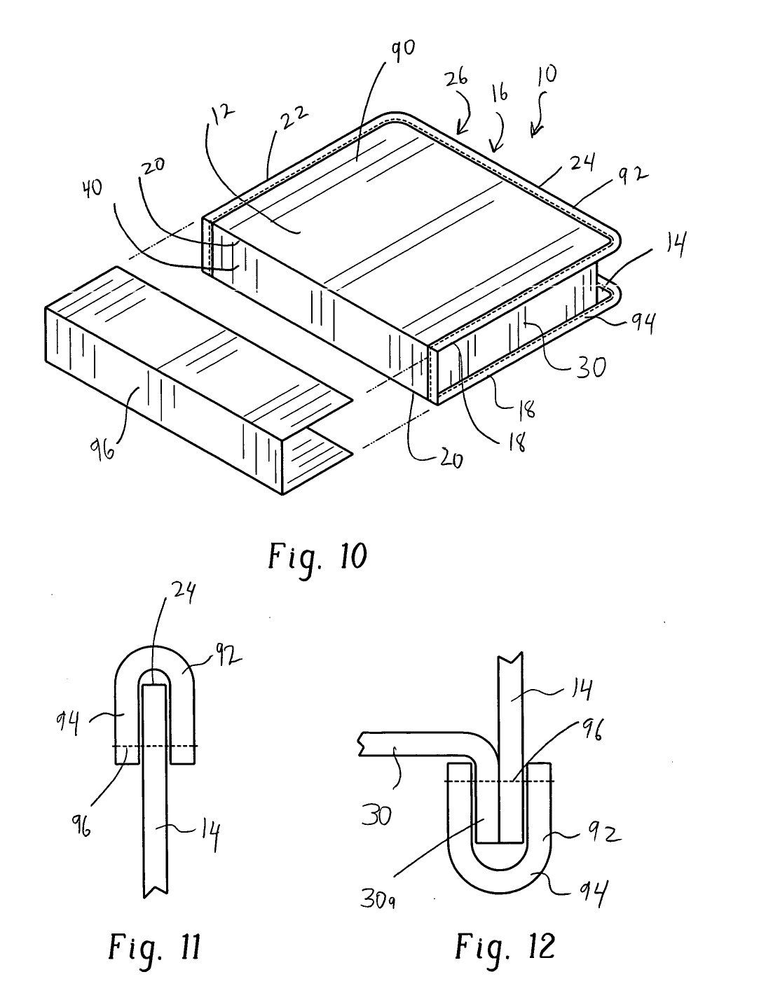

As shown in FIGS. 11 and 12, the binding seam 92 includes a piece of material 94 bent about itself to form a generally “U” shape. As shown in FIG. 11, when the binding seam 92 extends over only a single edge of material (i.e., upper edge 24 of the side panel 14), a stitching line 96 extends through both legs of the piece of material 94 and through the body of the panel 14. In this manner, the binding seam 92 provides a finished edge to present a clean appearance and protect the upper edge 26 of the panel 14.

As shown in FIG. 12, the binding seam 92 may also be utilized to join two pieces of material together. For example, in FIG. 12 the strip of material 30a and the panel 14 are located between the piece of material 94, and stitching line 96 extends through all four layers. In this manner, in addition to providing a clean finished edge to the notebook sleeve 10, the binding seam 92 serves to couple various ones of the panels of the notebook sleeve 10 together to provide a strong and secure structure for the notebook sleeve 10. In the arrangement shown herein, the binding seam 92 may be formed by a single strip of material 94 extending around various outer edges of the notebook sleeve 10. Alternately, however, the binding seam 92 may be formed by separate and/or spaced-apart strips of material 94.

As noted above, the binding seam 92 preferably does not extend along the lower longitudinal edges 20 of the notebook sleeve 10. This provides a distinct advantage in that when the user carries the notebook sleeve 10 by gripping the bottom panel 40 in the palm of the user's hand, the user does not grip the binding seams 92. Because the binding seams 92 protrude generally outwardly and may be relatively stiff and/or rough, it is much easier and more convenient to grip the notebook sleeve 10 along the bottom edges 20 without the presence of the binding seams 92.

As shown in FIG. 10, if desired, a finishing piece or piece of covering material 96 may be coupled to the bottom panel 40 and to lower portions of the first 12 and second 14 panels to provide an even smoother bottom surface to the notebook sleeve 10. The finishing panel 96 may be attached to the notebook sleeve 10 by stitching or other attachment means. Accordingly, the notebook sleeve 10 of the present invention may have a smooth lower surface 96 which extends from a lower portion of the first side panel 12, across the bottom panel 40 and to the second side panel 14 and which is smooth, continuous, and in one embodiment, generally unitary. This smooth bottom surface 96 of the notebook sleeve increases ease of handling and carrying.

Having described the invention in detail and by reference to the preferred embodiments, it will be apparent that modifications and variations thereof are possible without departing from the scope of the invention.

1. A notebook sleeve comprising:
a first generally rectangular side panel having a top edge, a pair of side edges and a bottom edge;
a second generally rectangular side panel having a top edge, a pair of side edges and a bottom edge, said second side panel being generally parallel to and generally aligned with said first side panel;
a bottom generally rectangular panel located between and coupled to said bottom edges of first and second side panels, said bottom panel having a pair of long edges and a pair of short edges; and
a pair of generally parallel connecting panels, each connecting panel being located between and coupled to a side edge of each of said first and second side panels, wherein said first side panel, said second side panel, said bottom panel and said pair of connecting panels define a cavity therebetween, wherein said first and second side panels each have a larger surface area than any of said bottom panel or said pair of connecting panels, and wherein at least one short edge of said bottom panel includes a binding seam extending at least partially therealong.

2. The notebook sleeve of claim 1 wherein each short edge of said bottom panel includes a binding seam extending at least partially therealong.

3. The notebook sleeve of claim 1 wherein each short edge of said bottom panel includes a binding seam extending generally entirely therealong.

4. The notebook sleeve of claim 1 wherein each connecting panel includes a pair of relatively long edges and a pair of relatively short edges, and wherein said notebook sleeve further includes a single binding seam extending along said top edges and side edges of both of side panels, along said both of said relatively long edges and along one of said relatively short edges of both of said connecting panels, and along both of said short edges of said bottom panel.

5. The notebook sleeve of claim 1 wherein each binding seam includes a flap of generally outwardly-extending material.

6. The notebook sleeve of claim 5 wherein each binding seam includes a relatively thin strip of material located over and stitched to said at least one short edge of said bottom panel.

7. The notebook sleeve of claim 6 wherein said binding seam couples at least one connecting panel to at least one of said side panels or said bottom panel.

8. The notebook sleeve of claim 1 wherein said notebook sleeve does not include any binding seams located adjacent to and extending along said bottom edges of said side panels.

9. The notebook sleeve of claim 1 wherein said notebook sleeve includes a piece of unitary covering material which extends across at least part of said bottom panel, at least part of said first side panel and at least part of said second side panel.

10. The notebook sleeve of claim 9 wherein said piece of covering material covers generally all of said bottom panel.

11. The notebook sleeve of claim 1 wherein each connecting panel is generally rectangular.

12. The notebook sleeve of claim 1 wherein said cavity includes a mouth located between said top edges of said side panels, and wherein said notebook sleeve includes a closure mechanism moveable between a closed position wherein said closure mechanism extends across said mouth to releasably couple said first and second panels together and an open position wherein said closure mechanism does not releasably couple said first and second panels together.

13. The notebook sleeve of claim 12 wherein said closure mechanism covers less than an entire length of said mouth when said closure mechanism.

14. The notebook sleeve of claim 1 wherein said connecting panels have lesser stiffness than said side panels.

15. The notebook sleeve of claim 1 wherein said bottom panel is oriented generally perpendicular to said side panels, and wherein said side panels are pivotally coupled to said bottom panel.

16. The notebook sleeve of claim 1 further comprising an auxiliary pocket located on one of said side panels.

17. The notebook sleeve of claim 16 wherein said auxiliary pocket includes an auxiliary pocket cavity and an auxiliary pocket mouth to provide access to said auxiliary pocket cavity, and wherein said auxiliary pocket mouth is oriented generally perpendicular to said mouth of said cavity of said notebook sleeve.

18. A notebook sleeve comprising:
a first generally rectangular side panel having a top edge, a pair of side edges and a bottom edge;
a second generally rectangular side panel having a top edge, a pair of side edges and a bottom edge, said second side panel being generally parallel to and generally aligned with said first side panel;
a bottom generally rectangular panel located between and coupled to said bottom edges of first and second side panels, said bottom panel having a pair of long edges and a pair of short edges;
a pair of generally parallel connecting panels, each connecting panel being located between and coupled to a side edge of each of said first and second side panels, wherein said first side panel, said second side panel, said bottom panel and said pair of connecting panels define a cavity therebetween, said cavity having a mouth, and wherein said first and second side panels each have a larger surface area than any one of said bottom panel or said pair of connecting panels, and wherein said notebook sleeve does not include any binding seams located adjacent to and extending along said bottom edges of said side panels; and
a closure mechanism movable between a closed position wherein said closure mechanism extends laterally across said mouth to releasably couple said side panels together and an open position wherein said closure mechanism does not releasably couple said side panels together, and wherein said closure mechanism extends less than an entire length of said mouth in a longitudinal direction when said closure mechanism is in said closed position.

19. The notebook sleeve of claim 18 wherein said closure mechanism is entirely spaced apart from the longitudinal ends of said top edges of said side panels.

20. A method for assembling a notebook sleeve comprising:
providing a main panel including a first generally rectangular side panel having a top edge, a pair of side edges and a bottom edge, a second generally rectangular side panel having a top edge, a pair of side edges and a bottom edge, and a bottom generally rectangular panel located between and coupled to said bottom edges of first and second side panels, said bottom panel having a pair of long edges and a pair of short edges;
folding said main panel such that said first and second side panels are generally parallel and aligned with each other and such that said bottom panel is generally perpendicular to said side panels;
providing a pair of connecting panels; and
attaching each connecting panel to a side edge of each of said first and second side panels such that said side panels are generally parallel and each side panel is located between said first and second side panels such that said first side panel, said second side panel, said bottom panel and said pair of connecting panels define a cavity therebetween, wherein said first and second side panels each have a larger surface area than any one of said bottom panel or said pair of connecting panels.

21. The method of claim 20 wherein said attaching step includes stitching a strip of material to said connecting panels and to said main panel thereby forming a binding seam where each connecting panel is attached to said side panels.

22. The method of claim 21 wherein each binding seam extends along a side edge of each side panel and along generally the entirely of said one of said short edges of said bottom panel.

23. The method of claim 20 wherein said notebook sleeve does not include any binding seams located adjacent to and extending along said bottom edges of said side panels.

24. The method of claim 20 further comprising the step of attaching a piece of unitary covering material to said main body such that such covering material extends across at least part of said bottom panel, at least part of said first side panel and at least part of said second side panel.

25. The method of claim 20 wherein said connecting panels have lesser stiffness than said side panels.
